(19) United States
(12) Patent Application Publication
(10) Pub. No.: US 2017/0106516 A1
(43) Pub. Date: Apr. 20, 2017

(54) FUEL TRANSMITTING DEVICE

(71) Applicant: BASSO INDUSTRY CORP., Taichung (TW)

(72) Inventors: An-Gi LIU, Taichung (TW); Chang-Sheng LIN, Taichung (TW); Fu-Ying HUANG, Taichung (TW)

(73) Assignee: BASSO INDUSTRY CORP., Taichung (TW)

(21) Appl. No.: 15/291,609

(22) Filed: Oct. 12, 2016

(30) Foreign Application Priority Data
Oct. 14, 2015 (TW) 104216439

(51) Int. Cl. B25C 1/08

(52) U.S. Cl. CPC B25C 1/08

(57) ABSTRACT

A fuel transmitting device is adapted for use in a gas nail gun which is formed with a combustion chamber and an accommodating chamber, and includes a cylinder cover, a door pivotable between a close position and an open position, and a connector. The cylinder cover is formed with a passage having an inlet that is proximate to the accommodating chamber and an outlet that is proximate to the combustion chamber. The connector has an input opening and an output opening. When the door is at the close position, the connector is received in the accommodating chamber and the output opening communicates with the inlet of the cylinder cover. When the door moves from the close position to the open position, the connector is removed from the accommodating chamber.

### CROSS-REFERENCE TO RELATED APPLICATION

This application claims priority of Taiwanese Patent Application No. 104216439, filed on Oct. 14, 2015.

### FIELD

The disclosure relates to a fuel transmitting device, and more particularly to a fuel transmitting device of a gas nail gun.

### BACKGROUND

As shown in FIGS. 1 and 2, a conventional gas nail gun 1 disclosed in U.S. Patent Application Publication No. 2008/0000451 includes a gun body 11, a door 12 pivotally mounted to the gun body 11, and a connector 13 pivotally mounted to the gun body 11. The gun body 11 has an accommodating chamber 111 for receiving a gas can 2. The connector 13 has a connecting head 131 communicating with the gas can 2, and a flexible connecting tube 132 connected to the connecting head 131. The door 12 is for covering the accommodating chamber 111 of the gun body 11. Therefore, a gas may flow into the gun body 11 through the connecting tube 132 and the connecting head 131.

However, since the connector 13 blocks an inlet of the accommodating chamber 111, a user has to push the connector 13 open in order to replace the gas can 2. After the gas can 2 is replaced, the gas can 2 has to be connected to the connecting head 131 first, and door 12 is then closed. The two step procedure leads to an inconvenient operation.

### SUMMARY

Therefore, the object of the disclosure is to provide a fuel transmitting device that can be operated in a simple and convenient manner.

According to the disclosure, the fuel transmitting device is adapted for use in a gas nail gun. The gas nail gun includes a gun body formed with a combustion chamber that is disposed for carrying out a combustion of a gas, and an accommodating chamber that is disposed for removably receiving a gas can. The gas can has a valve rod operable to release the gas. The fuel transmitting device includes a cylinder cover, a door and a connector. The cylinder cover is mounted to the gun body, and is formed with a passage communicating between the accommodating chamber and the combustion chamber. The passage has an inlet proximate to the accommodating chamber and an outlet proximate to the combustion chamber. The door is pivotally mounted to the gun body, is pivotable between a close position and an open position, and has an inner surface facing toward the accommodating chamber such that, when the door is at the close position, the accommodating chamber is covered, and when the door is at the open position, the accommodating chamber is uncovered. The connector is mounted to the inner surface of the door, and is formed with a flow path having an input opening and an output opening such that, when the door is at the close position, the connector is received in the accommodating chamber, the input opening is engaged by the valve rod of the gas can, and the output opening communicates with the inlet of the cylinder cover, and when the door moves from the close position to the open position, the connector is removed from the accommodating chamber.

### BRIEF DESCRIPTION OF THE DRAWINGS

Other features and advantages of the disclosure will become apparent in the following detailed description of the embodiment with reference to the accompanying drawings, of which:

FIG. 1 is a fragmentary perspective view of U.S. Patent Application Publication No. 2008/0000451;

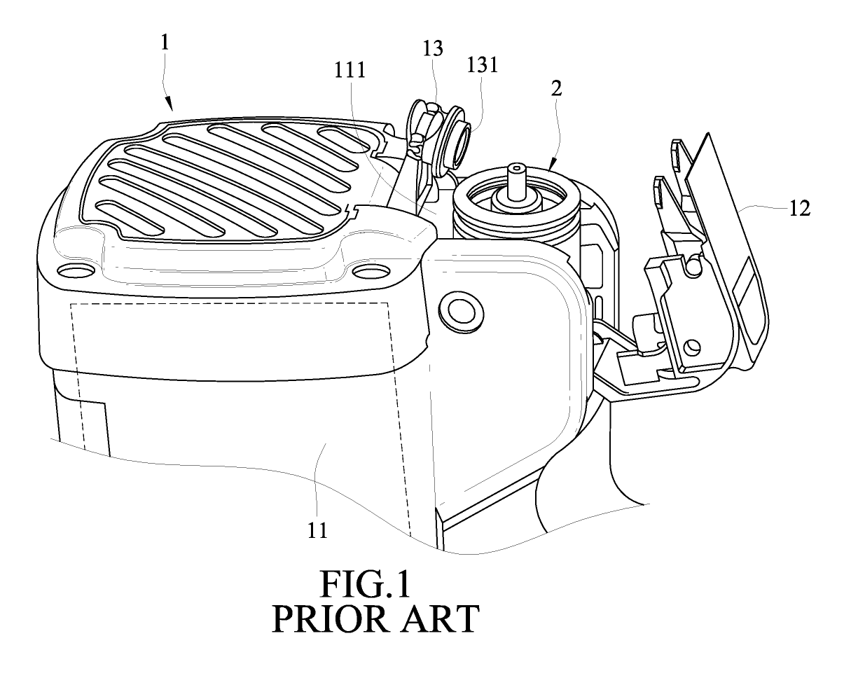

FIG. 2 is a fragmentary sectional view of the U.S. Patent Application Publication No. 2008/0000451;

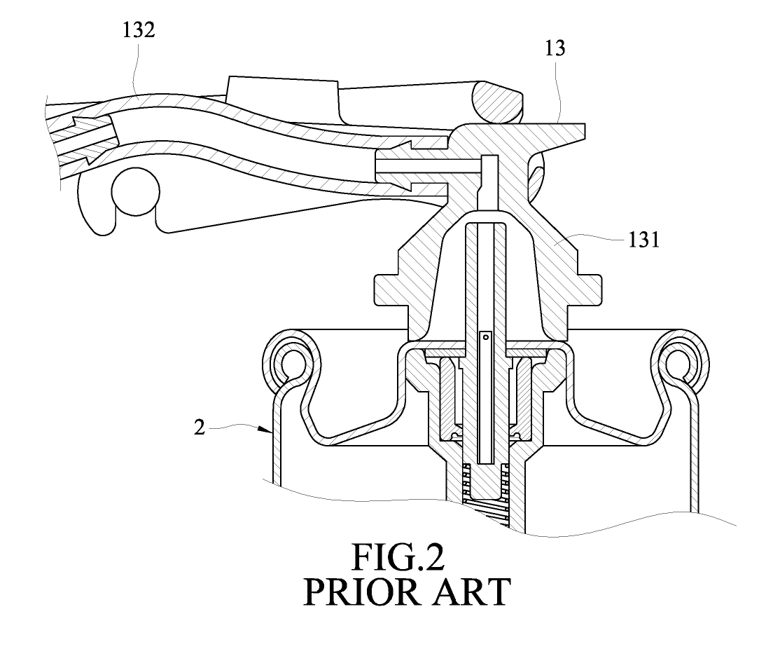

FIG. 3 is a sectional view of an embodiment of a fuel transmitting device of a gas nail gun according to the disclosure;

FIG. 4 is an exploded perspective view of a door, a connector and a resilient member of the embodiment;

FIG. 5 is a perspective view of the door, the connector and the resilient member of the embodiment;

FIG. 6 is a perspective view of the embodiment when the door is at an open position;

FIG. 7 is a view similar to FIG. 6 when the door is at a close position; and

FIG. 8 is an partly enlarged view of a portion of FIG. 3.

### DETAILED DESCRIPTION

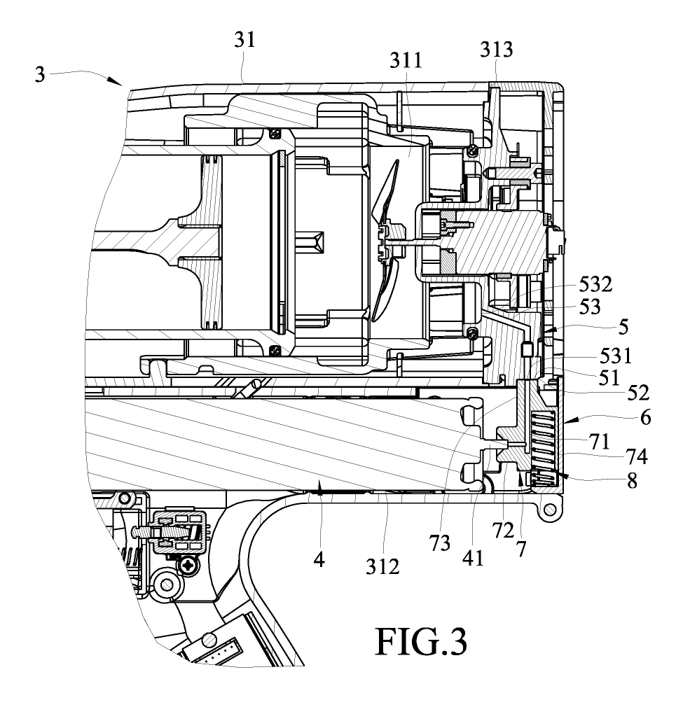

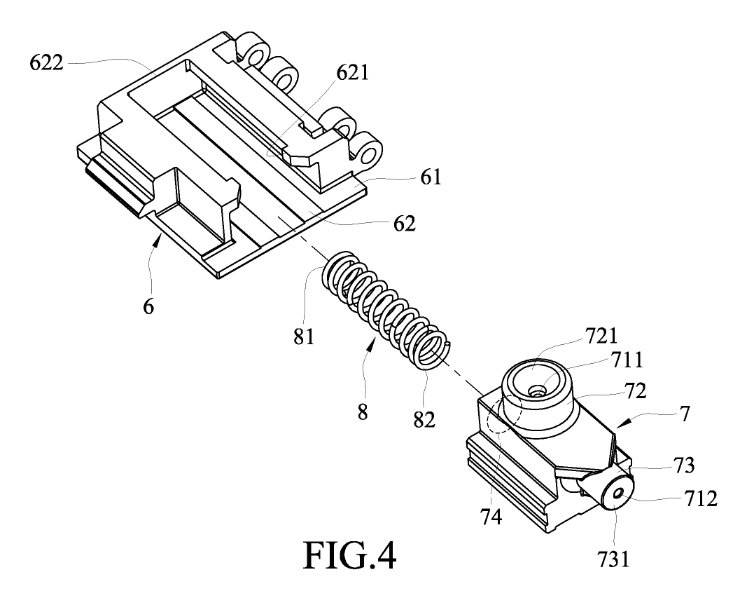

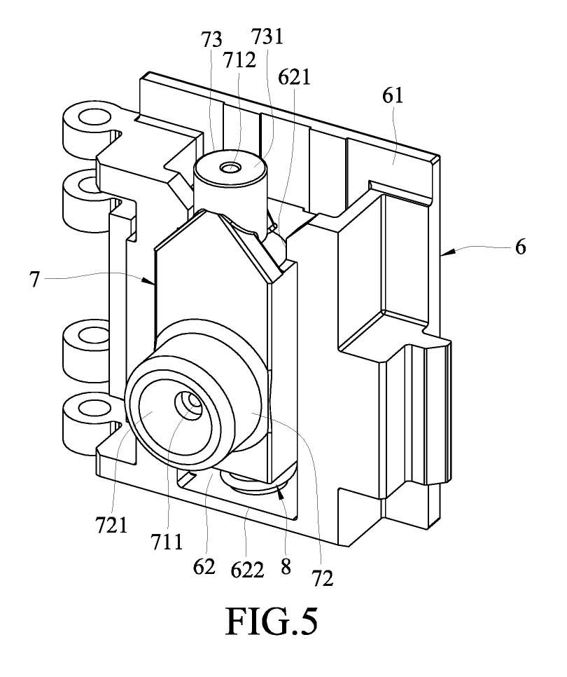

Referring to FIGS. 3 to 5, the embodiment of a fuel transmitting device according to the disclosure is for use in a gas nail gun 3. The gas nail gun 3 includes a gun body 31 formed with a combustion chamber 311 that is disposed for carrying out a combustion of a gas, an accommodating chamber 312 that is disposed for removably receiving a gas can 4, and a rear end portion 313. The gas can 4 has a valve rod 41 operable to release the gas. The fuel transmitting device includes a cylinder cover 5, a door 6, a connector 7 and a resilient member 8.

The cylinder cover 5 is mounted to the rear end portion 313 of the gun body 31, and has an abutted surface 51 facing toward the accommodating chamber 312 of the gas nail gun 3, and a guiding surface 52 forming an angle with the abutted surface 51. The cylinder cover 5 is formed with a passage 53 communicating between the accommodating chamber 312 and the combustion chamber 311, and having an inlet 531 that is proximate to the accommodating chamber 312 and an outlet 532 that is proximate to the combustion chamber 311.

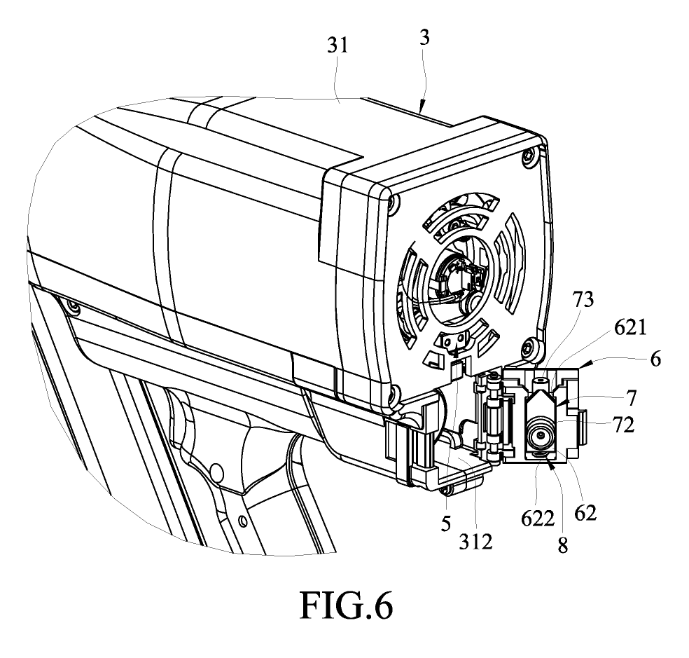

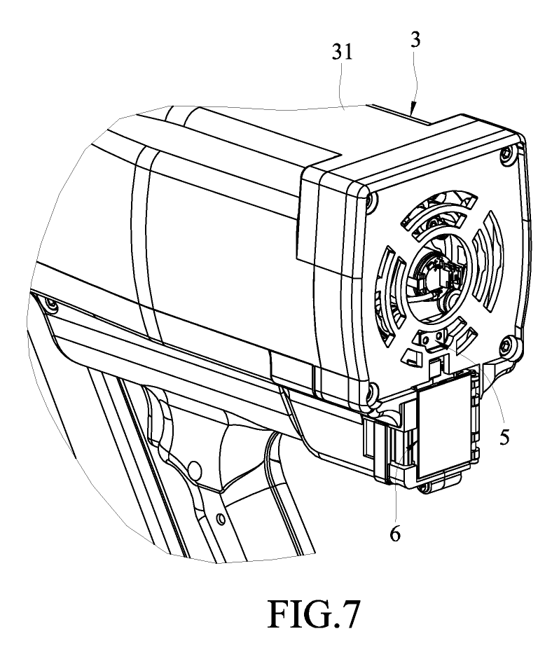

The door 6 is pivotally mounted to the gun body 31, is pivotable between a close position (see FIG. 7) and an open position (see FIG. 6), and has an inner surface 61 facing toward the accommodating chamber 312, and a guide slot 62 formed in the inner surface 61. The guide slot 62 has opposite stop end 621 and closed end 622.

The connector 7 is mounted to the inner surface 61 of the door 6, and is movably received in the guide slot 62 of the door 6. The connector 7 is formed with a flow path 71, and has a first annular projection 72 engaged by the valve rod 41 of the gas can 4, a second annular projection 73 having an end surface 731 that abuts against the abutted surface 51 of the cylinder cover 5, and a groove 74 having an opening that opens toward the closed end 622 of the guide slot 62. The flow path 71 has an input opening 711 formed in the first annular projection 72, and an output opening 712 formed in the second annular projection 73. The first annular projection 72 is formed with a frustoconical guiding surface 721 having a narrowest end that defines the input opening 711.

The resilient member 8 is disposed between the door 6 and the connector 7, and includes a first end portion 81 abutting against a wall of the door 6 that defines the closed end 622 of the guide slot 62, and a second end portion 82 having a portion that is received in the groove 74 of the connector 7. The resilient member 8 provides a resilient force to bias the connector 7 away from the door 6 to thereby abut against the abutted surface 51 of the cylinder cover 5.

As shown in FIG. 3, when the door 6 moves from the close position to the open position, the connector 7 no longer abuts against the abutted surface 51 of the cylinder cover 5 such that, the connector 7 is biased by the resilient member 8 to move along the guide slot 62 to the stop end 621 of the door 6, and is removed from the accommodating chamber 312 of the gun body 31. AS such, the accommodating chamber 312 is uncovered and a user can replace the gas can 4 without block of the connector 7.

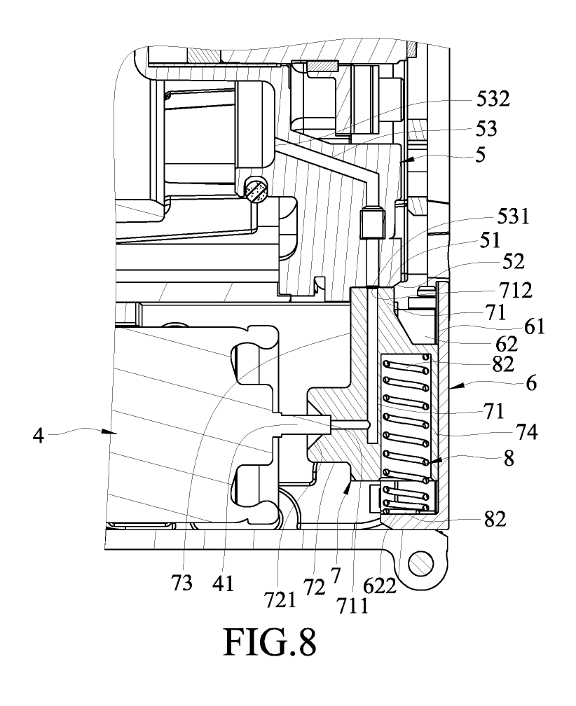

As shown in FIGS. 6 to 8, when the door 6 moves from the open position to the close position, the guiding surface 52 of the cylinder cover 5 pushes the connector 7 against the resilient force provided by the resilient member 8 so as to move the connector 7 toward the door 6. At the close position, the connector 7 is received in the accommodating chamber 312, and the end surface 731 of the second annular projection 73 of the connector 7 abuts against the abutted surface 51 of the cylinder cover 5 such that, the input opening 711 of the connector 7 is engaged by the valve rod 41 of the gas can 4, the output opening 712 of the connector 7 communicates with the inlet 531 of the passage 53 of the cylinder cover 5, and the accommodating chamber 312 is covered.

As such, the gas can 4 communicates with the combustion chamber 311 of the gas nail gun 3 through the input opening 711 and the output opening 712 of the flow path 71 of the connector 7, and the inlet 531 and the outlet 532 of the passage 53 of the cylinder cover 5.

With the abovementioned configuration, the fuel transmitting device of the disclosure has the following advantages:

When the door 6 is closed, the connector 7 can intercommunicate the combustion chamber 311 and the gas can 4. When the door 6 is opened, to replace the gas can 4, the gas can 4 can be removed from the accommodating chamber 312 of the gas nail gun 3 without block of the connector 7. As such, the gas can 4 can be replaced by simply opening and closing the door 6. A process for replacing the gas can 4 is simplified, thus resulting in convenience during operation.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A fuel transmitting device adapted for use in a gas nail gun, the gas nail gun including a gun body that is formed with a combustion chamber disposed for carrying out a combustion of a gas, and an accommodating chamber disposed for removably receiving a gas can, the gas can having a valve rod that is operable to release the gas, said fuel transmitting device comprising:
a cylinder cover mounted to the gun body, and formed with a passage that is adapted to communicate between the accommodating chamber and the combustion chamber, said passage having an inlet that is proximate to the accommodating chamber and an outlet that is proximate to the combustion chamber;
a door pivotally mounted to the gun body, pivotable between a close position and an open position, and having an inner surface that faces toward the accommodating chamber such that, when said door is at the close position, the accommodating chamber is covered, and when said door is at the open position, the accommodating chamber is uncovered; and
a connector mounted to said inner surface of said door, and formed with a flow path that has an input opening and an output opening such that, when said door is at the close position, said connector is received in the accommodating chamber, said input opening is engaged by the valve rod of the gas can, and said output opening communicates with said inlet of said cylinder cover, and when said door moves from the close position to the open position, said connector is removed from the accommodating chamber.

2. The fuel transmitting device as claimed in claim 1, wherein said connector is movable relative to said door, said cylinder cover having an abutted surface, said fuel transmitting device further comprising a resilient member that is disposed between said door and said connector for providing a resilient force to bias said connector away from said door such that, when said door is at the close position, said connector abuts against said abutted surface of said cylinder cover.

3. The fuel transmitting device as claimed in claim 2, wherein said cylinder cover further has a guiding surface that forms an angle with said abutted surface, and when said door moves from the open position to the close position, said guiding surface pushes said connector against the resilient force provided by said resilient member so as to move said connector toward said door.

4. The fuel transmitting device as claimed in claim 3, wherein:
said door further has a guide slot formed in said inner surface, disposed for movably receiving said connector, and having opposite stop end and closed end; and
said resilient member is disposed between said connector and a wall of said door defining said closed end of said guide slot such that, when said door moves from the close position to the open position, said connector is biased by said resilient member to move to said stop end of said door.

5. The fuel transmitting device as claimed in claim 4, wherein said connector is further formed with a groove having an opening that opens toward said closed end of said guide slot, and disposed for receiving a portion of said resilient member.

6. The fuel transmitting device as claimed in claim 1, wherein said connector further has a first annular projection formed with said input opening.

7. The fuel transmitting device as claimed in claim 6, wherein said first annular projection of said connector is further formed with a frustoconical guiding surface having a narrowest end that defines said input opening.

8. The gas fuel transmitting device as claimed in claim 6, wherein said connector further has a second annular projection formed with said output opening and having an end surface, and when said door is at the close position, said end surface of said second annular projection of said connector abuts against said abutted surface of said cylinder cover.

9. A gas nail gun adapted for removably receiving a gas can as a fuel source, the gas can having a valve rod that is operable to release a gas, said gas nail gun comprising:
a gun body unit formed with a combustion chamber that is disposed for carrying out a combustion of the gas, an accommodating chamber that is disposed for removably receiving the gas can, and a passage that communicates between said accommodating chamber and said combustion chamber, said passage having an inlet that is proximate to said accommodating chamber and an outlet that is proximate to said the combustion chamber;
a door pivotally mounted to said gun body unit, pivotable between a close position and an open position, and having an inner surface that faces toward said accommodating chamber such that, when said door is at the close position, said accommodating chamber is covered, and when said door is at the open position, said accommodating chamber is uncovered; and
a connector mounted to said inner surface of said door, and formed with a flow path that has an input opening and an output opening such that, when said door is at the close position, said connector is received in said accommodating chamber, said input opening is engaged by the valve rod of the gas can, and said output opening communicates with said inlet of said gun body unit, and when said door moves from the close position to the open position, said connector is removed from said accommodating chamber.

10. The gas nail gun as claimed in claim 9, wherein said gun body unit includes a gun body, and a cylinder cover mounted to said gun body, said combustion chamber and said accommodating chamber being separately formed in said gun body, said passage being formed in said cylinder cover.

11. The gas nail gun as claimed in claim 10, wherein said connector is movable relative to said door, said cylinder cover having an abutted surface, said gas nail gun further comprising a resilient member that is disposed between said door and said connector for providing a resilient force to bias said connector away from said door such that, when said door is at the close position, said connector abuts against said abutted surface of said cylinder cover.

12. The gas nail gun as claimed in claim 11, wherein said cylinder cover further has a guiding surface forming an angle with said abutted surface, and when said door moves from the open position to the close position, said guiding surface pushes said connector against the resilient force provided by said resilient member so as to move said connector toward said door.

13. The gas nail gun as claimed in claim 12, wherein:
said door further has a guide slot formed in said inner surface, disposed for movably receiving said connector, and having opposite stop end and closed end; and
said resilient member is disposed between said connector and a wall of said door defining said closed end of said guide slot, and when said door moves from the close position to the open position, said connector is biased by said resilient member to move to said stop end of said door.

14. The gas nail gun as claimed in claim 13, wherein said connector is further formed with a groove having an opening that opens toward said closed end of said guide slot, and disposed for receiving a portion of said resilient member.

15. The gas nail gun as claimed in claim 9, wherein said connector further has a first annular projection formed with said input opening.

16. The gas nail gun as claimed in claim 15, wherein said first annular projection of said connector is further formed with a frustoconical guiding surface having a narrowest end that defines said input opening.

17. The gas nail gun as claimed in claim 15, wherein said connector further has a second annular projection formed with said output opening and having an end surface, and when said door is at the close position, said end surface of said second annular projection of said connector abuts against said abutted surface of said cylinder cover.
